(19) United States
(12) Patent Application Publication
(10) Pub. No.: US 2006/0043155 A1
(43) Pub. Date: Mar. 2, 2006

(54) Method and system of friction welding

(76) Inventors: Jeff Lovin, Mishawaka, IN (US); Robert Adams, Granger, IN (US); Dan Kuruzar, Dowagiac, MI (US); Dietmar Spindler, Niles, MI (US)

Correspondence Address: BARNES & THORNBURG, 600 1ST SOURCE BANK CENTER, 100 NORTH MICHIGAN, SOUTH BEND, IN, 466011632, US

(21) Appl. No.: 10/924,633

(22) Filed: Aug. 24, 2004

(51) Int. Cl. B23K 20/12

(52) U.S. Cl. 228/102; 228/112.1

(57) ABSTRACT

A method and system of direct drive friction welding to reduce upset variation or reduce welded part length variation and a method and system of inertia friction welding to reduce upset variation. The system comprises a spindle which is configured to engage a part and a drive which is operatively connected to the spindle to rotate the spindle, and associated microprocessor based devices to store data and command the drive. The method comprises a sample friction weld of parts, and storing data in connection therewith, in order to generate a profile of upset versus speed. The method then, through the modulation of spindle drive torque, uses this profile for additional production friction welds having upset versus speed characteristics consistent with the profile of the sample weld during a deceleration phase of the friction weld.

### BACKGROUND

The present disclosure relates to a method and system of friction welding together parts.

There are generally two types of rotational friction welding, namely, inertia friction welding and direct drive friction welding. During a friction weld cycle, material from the work parts is displaced or “upset” which results in a reduction of the combined length of the welded parts. Thus, the finished product length is the sum of the length of the parts before the weld minus the effect of the upset experienced by the parts during the weld. Upset, and thus final product length, in friction welding is a variable that needs to be considered in friction welding. With increased demands on manufacturing tolerances it is desirable that friction welding processes consistently produce welded parts with lower tolerances of upset and produce consistent overall welded part lengths.

In inertia welding, upset is primarily dependent on starting energy (determined by starting speed and system inertia) and the load applied throughout the weld cycle. However, upset is also dependent on work part interfacial area, actual contact area between work parts and metallurgical properties, among other factors. Small variations in these variables are not compensated for and result in large variations in upset.

Controlling upset in direct drive friction welding consists of monitoring upset during the friction phase of the weld cycle, and transitioning to the forge/braking phase when the desired upset is achieved. Once the rotational driving force is discontinued at the end of the friction phase, though, upset occurs in an uncontrolled or natural process, dependent on prior energy input (determined by friction speed, applied load, and time), system inertia, and the friction/forge load applied as the spindle rotationally decelerates to rest.

### SUMMARY

The present disclosure comprises one or more of the following features or combinations thereof disclosed herein or in the Detailed Description below.

The present disclosure relates to a system and a method of direct drive friction welding together parts to produce welds having either reduced upset variation or reduced variation of the final length of the welded-together production parts. The present disclosure also relates to a method of inertia friction welding together parts to produce welds having reduced upset variation.

Reducing upset variation is achieved by dynamically controlling motor torque which affects the upset during the deceleration of the direct drive or inertia friction weld cycle. In the present disclosure, a pair of sample parts is welded to achieve a profile that represents the relationship between spindle speed and upset formation during the deceleration phase of the weld cycle. This stored profile data can thereafter be used as a basis for modulating torque applied during subsequent production weld cycles so that the upset is controlled during the deceleration of the spindle. The method can be carried out by any suitable welding system.

Additional features of the present disclosure will become apparent to those skilled in the art upon consideration of the following detailed description of illustrative embodiments of the disclosure.

### BRIEF DESCRIPTION OF THE DRAWINGS

The detailed description particularly refers to the accompanying figures in which:

FIG. 1 is an elevational view, schematic in nature, of a friction weld system in accordance with an embodiment of the present disclosure;

FIG. 2 is a diagram illustrating components of the weld system of FIG. 1;

FIG. 3 is a graph based on data relating to the formation of a sample weld formed by direct drive friction welding, illustrating spindle drive torque command, spindle angular velocity, upset, and pressure all on the vertical axis versus time represented on the horizontal axis, and also illustrating the various phases of a direct drive sample weld in accordance with an embodiment of the present disclosure;

FIG. 4 is a flowchart illustrating steps of a method for welding together sample parts during formation of the direct drive sample weld of FIG. 3 and illustrating steps of a method for welding together production parts based on the data acquired during the formation of the direct drive sample weld of FIG. 3;

FIG. 5 is a graph based on data relating to the formation of a production weld formed by direct drive friction welding, illustrating spindle drive torque command, spindle angular velocity, upset, and pressure all on the vertical axis versus time represented on the horizontal axis, and also illustrating the various phases of a direct drive production weld, based on the direct drive sample weld of FIG. 3, in accordance with an embodiment of the present disclosure;

FIG. 6 is a graph based on data relating to the formation of a sample weld formed by inertia friction welding, illustrating spindle drive torque command, spindle angular velocity, upset, and pressure all on the vertical axis versus time represented on the horizontal axis, illustrating the various phases of an inertia sample weld in accordance with an embodiment of the present disclosure;

FIG. 7 is a flowchart illustrating steps of a method for welding together parts during formation of the inertia sample weld of FIG. 6, and illustrating steps of a method for welding together inertia production parts based on data acquired during the formation of the inertia sample weld of FIG. 6;

FIG. 8 is a graph based on data relating to the formation of a production weld formed by inertia friction welding, illustrating spindle drive torque command, spindle angular velocity, upset, and pressure all on the vertical axis versus time represented on the horizontal axis, and also illustrating the various phases of an inertia production weld, based on the inertia sample weld of FIG. 6, in accordance with an embodiment of the present disclosure; and

FIG. 9 is a graph illustrating an example of upset setpoint, torque command response, spindle angular velocity response, and resultant upset response versus time during a torque modulated inertia weld cycle.

### DETAILED DESCRIPTION

While the present disclosure may be susceptible to embodiment in different forms, there is shown in the drawings, and herein will be described in detail, embodiments with the understanding that the present description is to be considered an exemplification of the principles of the disclosure and is not intended to limit the disclosure to the details of construction and the number and arrangements of components set forth in the following description or illustrated in the drawings.

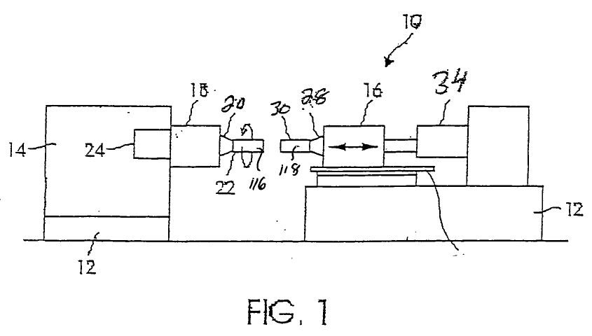

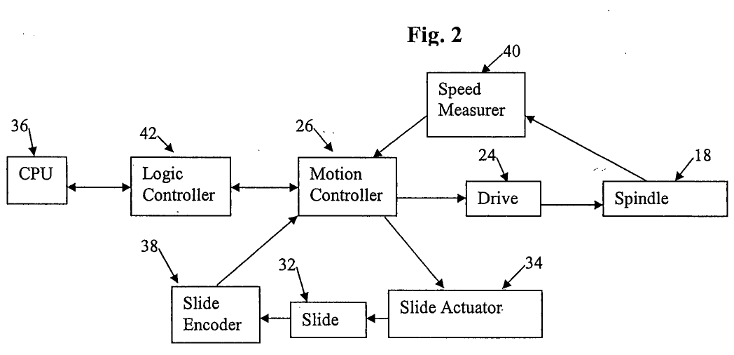

FIG. 1 illustrates a weld system 10 in the form of a friction welder 12. The friction welder 12 includes a headstock portion 14 and a tailstock portion 16 wherein the headstock portion 14 includes a spindle 18 having a rotating chuck 20 for engaging a first part or component 22. A drive 24 such as a motor is configured to apply a torque to the spindle 18 to rotate the spindle via commands from a motion controller 26 (FIG. 2). The spindle 18 may be equipped with additional mass, such as a flywheel, to increase the moment of inertia of the rotating spindle.

The tailstock portion 16 includes a non-rotating chuck 28 for engaging a second part or component 30. The tailstock portion 16 mounts to a slide 32 wherein a slide actuator 34 slides the non-rotating chuck 28 toward the rotating chuck 20. Since the rotating chuck 20 and the non-rotating chuck 28 engage the first part 22 and the second part 30, respectively, the first part 22 and the second part 30 contact each other during the weld cycle as will be discussed.

Turning to FIG. 2, the weld system 10 is shown in schematic form further comprising the drive 24, a slide actuator 34, a central processing unit (CPU) 36, the motion controller 26, a slide encoder 38, a speed measurer 40, and a logic controller 42. The CPU 36 provides an interface to the operator to allow weld parameter entry and storage of weld parameters and communicates the weld parameters to the logic controller 42. The CPU 36 also reads weld data from the logic controller 42, provides an interface to display the weld data to the operator, and stores the weld data. The drive 24 applies torque to rotationally accelerate, decelerate, or maintain the rotational speed of the spindle 18 (FIG. 1). The slide encoder 38 measures and signals the linear position of the slide 32 to the motion controller 26 wherein the motion controller 26 represents the intelligence that accepts commands related to slide position from the logic controller 42 and translates those commands into commands issued to the slide actuator 34 which moves the slide 32. The slide actuator 34 may comprise a hydraulic cylinder, although, any device capable of providing an axial force could be used.

The speed measurer 40 measures and signals the rotational speed of the spindle 18 to the motion controller 26, wherein the motion controller 26 represents the intelligence that accepts commands related to spindle speed from the logic controller 42 and translates those commands into commands issued to the drive 24. The motion controller 26 has the ability to monitor the spindle speed information supplied by the speed measurer 40 and adjust the torque output of the drive 24 in real time. The logic controller 42 controls the functions and sequences of the weld system 10 and the friction welder 12 according to the weld parameters supplied by the operator via the CPU 36. The source code for the CPU 36 and the logic controller 42 may be written in any suitable manner.

The CPU 36 operatively connects to the logic controller 42 which is operatively connected to the motion controller 26. The motion controller 26 operatively connects to the drive 24 to command the drive 24 to rotate the spindle 18. The motion controller 26 also operatively connects to the slide actuator 34 to move the slide 32, wherein the slide encoder 38 measures the linear position of the slide 32 as it moves during the formation of the weld at set time intervals while the speed measurer 40 measures the speed of the spindle 18. Accordingly, the slide encoder 38 and speed measurer 40 are operatively connected to the motion controller 26 such that the motion controller 26 analyzes the spindle angular velocity and slide position during different inertia weld phases such as an acceleration phase, a disengaged phase, a thrust phase and a deceleration phase, and during different direct drive weld phases such as acceleration phase, a first friction phase, a second friction phase, a braking phase, and a forge phase.

As known in the art, the spindle drive torque command and spindle drive torque may be essentially identical in a correctly functioning machine since drive torque would be slightly delayed beyond the resolution of the time base. Additionally, pressure is directly related to the axial force applied to bring the two meeting faces of the components under load, since pressure is proportional to force in a hydraulic cylinder. Further, upset caused during formation of a weld equals the reduction of lengths of the component parts as the component parts are friction welded together. Upset zero position may be the position of the slide under maximum weld load where the two meeting faces of the components are in contact with each other with zero upset formation. Upset deceleration position may be the position of the slide when the weld system initiates the deceleration phase of the friction welding cycle. Upset position may be the position of the slide when the spindle achieves zero velocity after the deceleration phase of the friction welding cycle. Upset final position may be the position of the slide under maximum weld load where the parts are welded together with final upset formation, wherein the final upset equals the displacement of the slide caused by the upset formed by the welding process. Length as used herein, is intended to mean, for example, the length of the parts as measured along the direction of slide movement and thus the direction of force applied to the component parts. Additionally, although the term in physics for spindle rotation is spindle angular velocity; the term, spindle speed, is typically used as standard terminology for friction weld parameters.

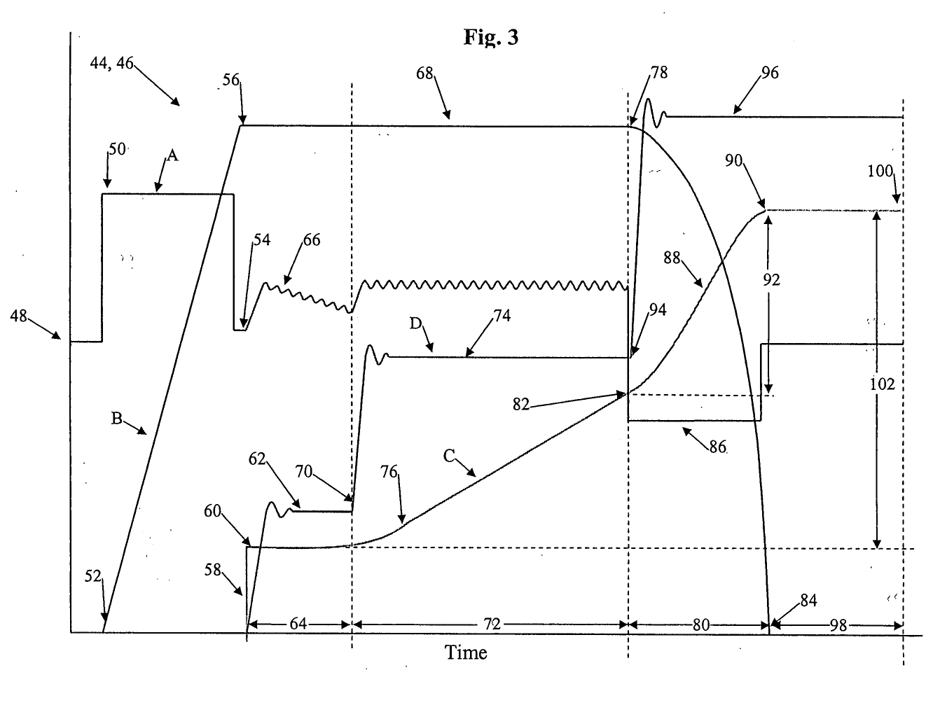

Referring to FIG. 3, the formation of a direct drive sample weld 44 is shown graphically, wherein the horizontal axis represents time and the vertical axis represents various measured values and system commands during formation of the direct drive sample weld 44. To form the direct drive sample weld 44, the operator first inputs weld parameters that define a direct drive sample cycle 46. The operator then loads the pair of sample parts 22, 30 (FIG. 1) by engaging the first sample part 22 with the rotating chuck 20 (FIG. 1) connected to the spindle 18 (FIG. 1) and the second sample part 30 with the non-rotating chuck 28 (FIG. 1) connected to the slide 32 (FIG. 1). The operator then issues a start command 48 to initiate the direct drive sample cycle 46.

The motion controller 26 (FIG. 2) issues a torque command 50 to the drive 24 (FIG. 2) to begin rotationally accelerating the spindle 18, wherein trace “A” in FIG. 3 represents torque applied by the drive 24 to the spindle 18. The spindle 18, initially at rest, begins an initial rotation 52 during an acceleration phase, wherein trace “B” in FIG. 3 represents the speed of the spindle 18 during formation of the direct drive sample weld 44. The torque command 50 applied to the spindle 18 drops to a lower level 54 when a predetermined friction speed 56 is attained by the spindle 18. Since the spindle 18 is under closed loop velocity control via the motion controller 26, the torque required to maintain constant speed may fluctuate. Once this friction speed 56 is attained, the motion controller 26 commands the slide actuator 34 (FIG. 2) to move the slide 32 to contact the opposed meeting faces of the two sample parts 22, 30. This movement is illustrated in the upset trace 58 as the slide 32 moves the meeting faces of the two sample parts 22, 30 together, wherein trace “C” in FIG. 3 represents the upset formed during the direct drive sample cycle 46. At initial contact of the meeting faces of the sample parts 22, 30, the motion controller 26 and the slide encoder 38 (FIG. 2) establish an upset zero position 60.

Following initial contact of the sample parts 22, 30, pressure builds to a first friction pressure 62 during a first friction phase 64 wherein trace “D” in FIG. 3 represents pressure between the sample parts 22, 30. The friction due to the contact of the sample parts 22, 30 puts an additional torque 66 on the spindle 18. The spindle 18, however, remains under closed loop velocity control via the motion controller 26. As such, the motion controller 26 commands the drive 24 to respond to this additional torque 66 to maintain constant speed 68 of the spindle 18. The drive torque required to maintain the constant speed 68 typically decreases as the temperature at the weld interface between the sample parts 22, 30 increases. During the first friction phase 64, the weld system 10 maintains the first friction pressure 62.

Once a predetermined time [“first friction time”] is complete, the weld system 10 begins to apply an increased pressure 70, which completes the first friction phase 64 and starts the second friction phase 72 of the direct drive sample cycle 46. The second friction phase 72 of the cycle is characterized by application of an increased second friction pressure 74. The combination of the first friction phase 64 and the second friction phase 72, comprises the friction phase of the direct drive sample cycle 46. At some point in the friction phase, the energy input generates enough heat for the specific material and geometry of the sample parts 22, 30 to plasticize sufficient material which allows upsetting 76 to occur as represented by trace “C” in FIG. 3.

The end 78 of second friction phase 72 is triggered by time [“friction time”] in a friction-to-time weld cycle, or upset [“friction distance”] in a friction-to-distance weld cycle, or slide position [“friction limit position”] in a friction-to-finished-length weld cycle, the friction-to-time weld cycle, the friction-to-distance weld cycle and the friction-to-finished-length weld cycle being common friction weld cycle variations. At the end of the second friction phase 72, a braking phase 80 of the direct drive sample cycle 46 initiates wherein the braking phase 80 may be executed by different procedures. Upon initiation of the braking phase 80, an upset deceleration position 82 is determined. In an embodiment, the spindle 18 may be maintained in a velocity loop, and a velocity controlled deceleration via the motion controller 26 to zero velocity can occur within a specified time [not shown]. Alternatively, the drive 24 may rotationally decelerate the spindle 18 to rest, or zero velocity 84, in torque mode by applying a brake torque 86 to the spindle 18. The brake torque 86 can optionally be delayed by applying zero motor torque prior to applying the brake torque 86, wherein this zero torque delay period is still included in the braking phase 80. The brake torque 86 may also be applied after a predetermined time, i.e. a brake delay time (not shown), or at a given speed, i.e. a braking speed (not shown). The braking phase 80 ends at zero velocity 84 of the spindle 18. In the formation of the direct drive sample weld 44, the formation of upset 88 is not controlled during the braking phase 80 and is influenced by the natural characteristics of the direct drive sample weld 44, e.g. metallurgy of materials, geometry, etc. Upon completion of the braking phase 80 at zero velocity 84, the formation of upset 88 may continue. An upset position 90 is determined after the spindle 18 achieves zero velocity 84. At the end of the braking phase 80, a deceleration upset 92 may be calculated based on the difference between the upset deceleration position 82 and the upset position 90. This deceleration upset 92 represents the displacement of the slide 32 and the reduction of lengths of the sample parts 22, 30 caused by the formation of upset 88 during the braking phase 80.

The end of the second friction phase 72 signals the transition into a forge phase 94 wherein pressure increases to a forge pressure 96 from the second friction pressure 74. The forge phase 94 may start immediately at the end of second friction phase 72. Alternatively, the forge phase 94 may be delayed after the second friction phase 72 and start after a predetermined forge delay time (not shown), or at a given spindle velocity, i.e. a forge speed (not shown), or at zero velocity 84 of the spindle 18 (not shown).

Once the braking phase 80 ends at zero velocity 84 of the spindle 18, a forge cooling dwell period 98 initiates in which forge pressure 96 is maintained for a predetermined period of time. During the forge cooling dwell period 98, the upset 88 may continue to increase.

An upset final position 100 is determined after the slide 32 movement toward the spindle 18 ceases. At the end of the forge cooling dwell period 98 when the slide 32 reaches a rest position, a total upset 102 of the direct drive sample weld 44 may be calculated based on the difference between the upset zero position 60 and the upset final position 100. As such, the total upset 102 represents the displacement of the slide 32 and the reduction of lengths of the sample parts 22, 30 caused by the formation of the upset during the direct drive sample cycle 46.

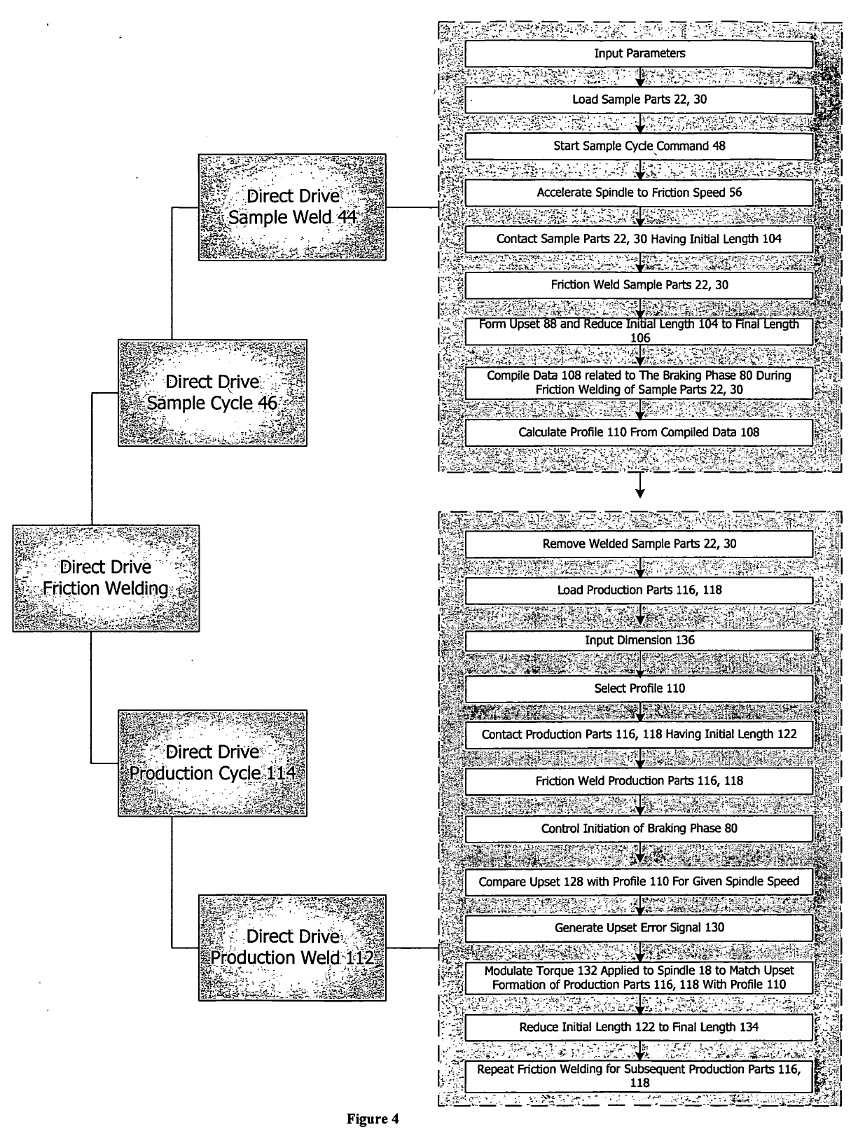

Turning to FIG. 4 and referring to FIG. 3, a flowchart illustrates steps of the direct drive sample cycle 46 for the formation of the direct drive sample weld 44. As illustrated, the operator first inputs weld parameters that define the direct drive sample cycle 46. The operator then loads the pair of sample parts 22, 30 by engaging the first sample part 22 with the rotating chuck 20 connected to the spindle 18 while engaging the second sample part 30 with the non-rotating chuck 28. The operator then issues the start command 48 to initiate the direct drive sample cycle 46. Next the spindle 18 rotationally accelerates to the friction speed 56 which is maintained as a constant speed.

The motion controller 26 then commands the slide actuator 34 to move the slide 32 to contact the opposed meeting faces of the two sample parts 22, 30 wherein the sample parts 22, 30 have a combined initial length 104 when sample part 30 contacts sample part 22. Upon contact, the motion controller 26 and the slide encoder 38 establish the upset zero position 60. Once the first friction phase 64 is complete, the weld system 10 begins to apply the increased pressure 70 to initiate the second friction phase 72. At the end of the second friction phase 72, the braking phase 80 of the direct drive sample cycle 46 initiates to rotationally decelerate the spindle 18 to zero velocity 84.

During the braking phase 80 of the direct drive sample weld cycle 46, the upset 88 formation is not controlled. When the spindle 18 achieves zero velocity 84 at the end of the braking phase 80, the forge cooling dwell period 98 initiates in which the upset 88 may continue to increase. At the end of the forged cooling dwell period 98, the total upset 102 of the direct drive sample weld cycle 46 can be calculated based on the difference between the upset zero position 60 and the upset final position 100. The formation of the direct drive sample weld 44 causes the upset to form which reduces the combined initial length 104 of the sample part 22, 30 to a welded final length 106.

While executing the direct drive sample weld 44, the weld system 10 acquires weld data 108 that can be used to characterize the rotational deceleration of the spindle 18 and the axial movement of the slide 32, and thus the upset 88, during the braking phase 80 of the direct drive sample cycle 46 for the specific parts to be welded in subsequent production welds. The upset 88 that forms during the braking phase 80 of this direct drive sample weld 44 is subject to some inherent and unpredictable variations. However, weld data 108 acquired during the formation of the direct drive sample weld 44 can be analyzed to determine the upset 88 and the speed of the spindle 18 at various instants in time from the end 78 of friction phase to zero velocity 84 of the spindle 18, i.e., during the braking phase 80.

During the formation of the direct drive sample weld 44, the weld system 10 measures and stores weld data 108 at specific time intervals. The weld data 108 serve as a basis for calculating the upset versus spindle velocity profile as will be discussed. The weld data 108 are typically measured during the entire weld cycle, but the measurements are particularly critical during the braking phase 80 of the direct drive sample cycle 46. Additionally, thrust pressure may also be measured and stored with the weld data 108. During the formation of the sample weld 44, the weld data 108 are acquired and temporarily stored by the logic controller 42.

When the direct drive sample cycle 46 is complete, the CPU 36 reads the weld data 108 from the logic controller 42, displays the results to the operator, and stores a complete record of the weld data 108. The weld data 108 measured and stored can be in any suitable form that can then be used to form subsequent production welds requiring the same characteristic upset versus spindle velocity profile as was measured during the braking phase 80 of the sample direct drive weld cycle 46. In the illustrated flowchart, the weld data 108 are used to calculate a profile 110. The weld data 108 include the speed of the spindle 18 as a function of time which may be represented as two discrete arrays, one array of spindle speeds and an associated array of time values at which the spindle speed was measured. The weld data 108 used in the calculation of the profile 110 further include the position of the slide 32 as a function of time represented as two discrete arrays, one array of slide positions and an associated array of time values at which the slide position was measured. The weld data 108 also include the upset zero position 60 so that upset can be calculated from the slide position data.

The weld data 108 are compiled into the profile 110, wherein the profile 110 is a calculated model of the relationship of the characteristic formation of the upset 88 versus the speed of the spindle 18 during the braking phase 80 of the sample direct drive sample cycle 46. The profile 110 then serves as a basis for controlling subsequent production welds in order to match the displacement of the sample part 30 caused by the upset 88 at any given spindle velocity during the braking phase 80 and, thus, eliminate the inherent upset variation during the braking phase 80 in a production direct drive weld to produce either consistent reduction of lengths or consistent final product lengths as will be discussed.

In the present disclosure, the profile 110 is represented by a lookup table that provides upset 88 formation as a function of spindle speed. In other words, the profile 110 is an array in which the indices of the array are a factor of speed and the values stored in the array represent the upset 88 that was measured at the corresponding spindle speed. Thus, at any given speed, the corresponding upset setpoint can be looked up for that speed. An index is calculated by multiplying the floating point representation of current speed and a floating point representation of a spindle-speed-to-index scaling factor, and rounding the result to produce an integer index. Since the weld data 108 are acquired through digital acquisition rates, the weld data 108 must be interpolated to fill in spindle velocity points where no actual data sample was measured to achieve a complete array for the profile 110.

After the CPU 36 calculates the profile 110 from the weld data 108 of the direct drive sample weld 44, the welded component is removed in order to execute any number of subsequent direct drive production welds as will be discussed.

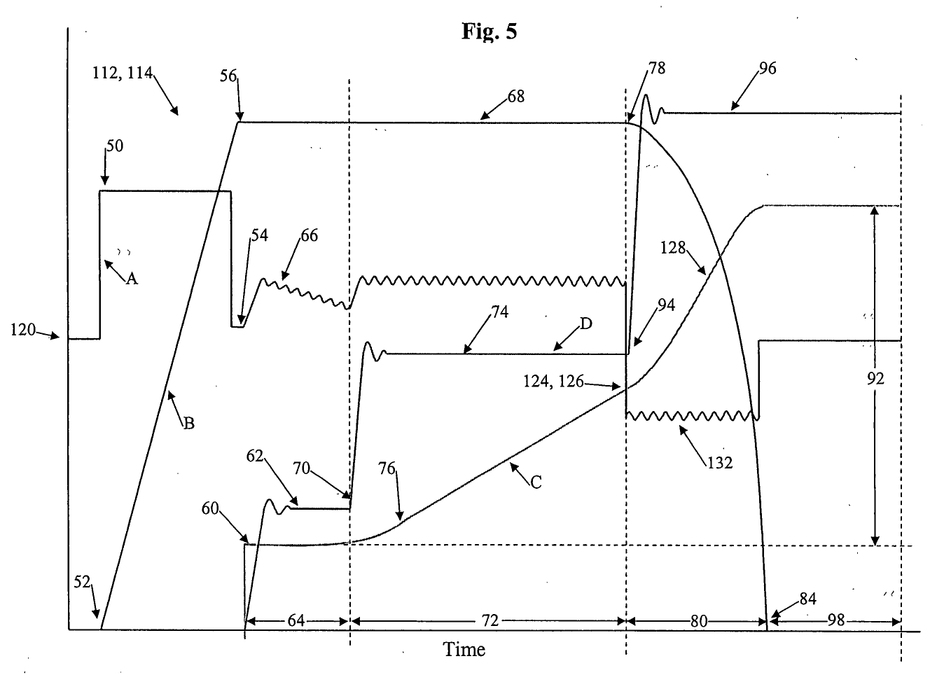

Turning to FIG. 5 and referring to FIG. 4, the formation of a direct drive production weld 112 is shown graphically, wherein the horizontal axis represents time and the vertical axis represents various measured values and system commands during formation of the direct drive production weld 112, in accordance with an embodiment of the present disclosure. To form the direct drive production weld 112, the operator first inputs weld parameters that define a direct drive production weld cycle 114. The operator then loads the pair of production parts 116, 118 (FIG. 1) by engaging the first production part 116 with the rotating chuck 20 (FIG. 1) while engaging the second production part 118 with the non-rotating chuck 28 (FIG. 1). Additionally, a profile 110 (FIG. 4) is then selected. Any number of direct drive sample welds 44 (FIGS. 3 and 4) may be executed, and the weld data 108 (FIG. 4) from these direct drive sample welds 44 may be compiled into various sample profiles 110 and stored on the CPU 36 (FIG. 2). The profile 110 that is most suitable for the current configuration of production parts 116, 118 is selected from the list of available profiles 110. The direct drive production welds 102 may be either torque modulated upset controlled direct drive welds or torque modulated final part length controlled direct drive welds.

The cycle characteristics of a direct drive production cycle 114 are identical with the characteristics of the direct drive sample cycle 46 through the end of the second friction phase 72 or the beginning of braking phase 80, wherein FIG. 5 illustrates the same reference numerals as FIG. 3 for common values and system commands. Any parameter that affects the deceleration rate of the spindle 18 is unchangeable in the direct drive production weld 112, and is duplicated from the selected direct drive sample weld 44. These parameters include friction speed, brake torque, brake speed, brake delay time, forge pressure, forge speed, and forge delay time. If these parameters need to be changed, a new direct drive sample weld 44 and corresponding profile 110 must be processed and stored. The CPU 36 calculates any additional required parameters based on the parameters input by the operator and the characteristics of the sample profile 110 selected. All of the parameters, including the profile 110 array of upset versus speed are communicated to the logic controller 42 from the CPU 36.

Referring to FIG. 5, the weld system 10 begins friction welding together the pair of production parts 116, 118 to form the direct drive production weld 112. After weld parameters are input by the operator and the first production part 116 and the other production part 118 are engaged, the operator then issues a start command 120 for the direct drive production cycle 114. After the spindle is accelerated to friction speed 56, the motion controller 26 commands the slide actuator 34 to move the slide 32 to contact the opposed meeting faces of the two production parts 116, 118 wherein the production parts 116, 118 have a combined initial length 122 when production part 118 contacts production part 116. The direct drive production cycle 114 proceeds as described above in the direct drive sample cycle 46. If the objective of the direct drive production cycle 114 is final upset control, the braking phase 80 initiates when a friction upset distance 124 is achieved. If the objective of the direct drive production cycle 114 is final product length control, the braking phase 80 initiates when the friction limit position 126 is achieved.

During the braking phase 80 of the direct drive production weld cycle 114, the motion controller 26 compares actual upset 128 formation to the upset setpoint dictated by the profile 110 for the current actual speed of the spindle 18 to generate an upset error signal 130 as shown in the flowchart of FIG. 4. In the present disclosure, the current upset setpoint at any instant in time can be looked up from the profile 110 based on the current speed of the spindle 18. The current actual upset 128 can be subtracted from the current upset setpoint to generate the upset error signal 130. Thus, returning to FIG. 5, during the braking phase 80 of the direct drive production cycle 114, the drive 24 modulates torque 132 applied to the spindle 18 so that the upset 128 at any given spindle speed during the formation of the direct drive production weld 112 is formed in accordance with the profile 110 measured during the formation of the direct drive sample weld 44 to produce upset 128 consistent with the upset 88 formed during the braking phase 80 of the direct drive sample weld 44.

The upset error signal 130 from either the upset controlled direct drive weld or the final part length controlled direct drive weld is used to modulate torque 132 applied to the spindle 18 during the braking phase 80. If the actual upset 128 forming in the direct drive production cycle 114 is less than upset setpoint in the profile 110 at any given speed, the drive 24 applies positive torque 132 to the spindle 18. If the actual upset 128 forming in the direct drive production cycle 114 is greater than the upset setpoint in the profile 110 at any given speed, the drive 24 applies negative or braking torque 132 to the spindle 18. Accordingly, during the braking phase 80, the modulated torque 132 compensates for the upset error signal 130 to form the upset 128 in accordance with the profile 110. As such, the modulated torque 132 continuously increases or decreases the deceleration of the spindle 18 during the braking phase 80 to consistently form the upset 128 in accordance with the formation of upset 88 of the direct drive sample weld 54.

The upset error signal 130 is driven into a PID algorithm (Proportion—Integral—Derivative) producing the modulated torque signal 132 that is issued to the drive 24 to compensate for the upset error signal 130. As such, the modulated torque 132 applied to spindle 18 during the formation of the direct drive production weld 112 causes the upset at any given spindle speed to form in accordance with the profile 110 so that the upset 128 experienced during the formation of the direct drive production weld 112 is consistent with the upset 88 experienced during the formation of the direct drive sample weld 44. Still further, the modulated torque 132 applied to spindle 18 during the formation of the direct drive production weld 112 causes the displacement of the slide 32 caused by the upset 128 to match the displacement of the slide 32 experienced during the formation of the direct drive sample weld 44.

In an embodiment for controlling the final part length, the profile 110 calculated from the direct drive sample cycle 46 is further used to control the final length 134 for the welded production part. Since the modulated torque 132 forms the upset 128 following the onset of the deceleration phase 72 in accordance with the profile 110, the deceleration can be initiated so that the total upset 92 reduces the combined initial length 122 to the specified final welded part length 134. In this embodiment, after providing the production parts 116, 118 and before rotationally accelerating production part 116 the operator specifies the dimension 136 for the final length 134 of the welded production part. The weld system then controls initiation of the rotational deceleration of production part 116, i.e. the braking phase 80. As such, the torque modulation applied to the production part 116 is controlled so that the sum of the upset 76 formed prior to the braking phase 80 and the upset 128 formed during and after the braking phase 80 reduces the final length 134 to the desired dimension 136. In an embodiment, the initial lengths 104, 106 and final lengths 122, 124 of the sample parts 22, 30 and production parts 116, 118 may represent initial and final axial lengths of the sample parts 22, 30 and production parts 116, 118.

In the present disclosure, the closed loop control algorithm for generating the modulated torque command 132 signal based on the current upset error signal 130 is implemented in a standard digital independent positional PID algorithm with derivative on error. Alternatively, the closed loop control algorithm could be implemented in any suitable algorithm including, but not limited to, a dependent algorithm or a velocity algorithm. The algorithms may be implemented in the logic controller 42 in any suitable manner. The direct drive production cycle 114 described for the formation of the direct drive production weld 112 may be subsequently repeated to weld together on a volume basis any number of additional production parts 116, 118.

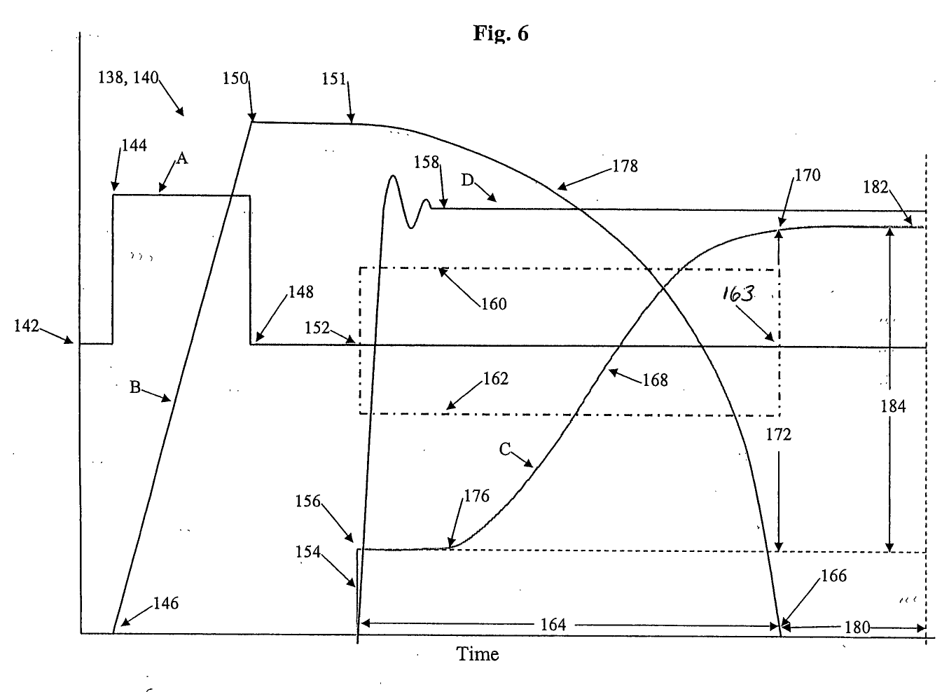

Referring to FIG. 6, the formation of an inertia sample weld 138 is shown graphically, wherein the horizontal axis represents time and the vertical axis represents various measured values and system commands during formation of the inertia sample weld 138, in accordance with an embodiment of the present disclosure. To form the inertia sample weld 138, the operator first inputs weld parameters that define an inertia sample cycle 140. The operator then loads the pair of sample parts 22, 30 (FIG. 1) by engaging the first sample part 22 with the rotating chuck 20 (FIG. 1) connected to the spindle 18 (FIG. 1), while engaging the second sample part 30 with the non-rotating chuck 28 (FIG. 1). The operator then issues a start command 142 to initiate the inertia sample cycle 140.

The motion controller 26 (FIG. 2) issues a torque command 144 to the drive 24 to begin rotationally accelerating the spindle 18, wherein trace “A” in FIG. 6 represents the torque applied by the drive 24. The spindle 18, initially at rest, begins an initial rotation 146 during an acceleration phase, wherein trace “B” in FIG. 6 represents the speed of the spindle 18 during formation of the inertia sample weld 138. The torque command 144 applied to the spindle 18 drops to zero 148 when a predetermined disengage speed 150 is attained. During this disengage phase, the spindle 18 rotates free from any influence from the drive 24. The spindle 18 rotationally decelerates at a rate dependent on the inertia and frictional losses inherent in the weld system 10. Once the spindle 18 rotationally decelerates naturally to a preset weld speed 151, the motion controller 26 commands the slide actuator 34 (FIG. 2) to move the slide 32 (FIG. 2) to contact the opposed meeting faces of the two sample parts 22, 30. This is illustrated in initial upset trace 154 as the slide 32 moves the meeting faces of the two sample parts 22, 30 together, wherein trace “C” in FIG. 6 represents the upset formed during the inertia sample cycle 140. At initial contact of the meeting faces of the sample parts 22, 30 the motion controller 26 and the slide encoder 38 (FIG. 2) establish an upset zero position 156.

During the contact of the sample parts 22, 30, pressure builds to weld pressure 158 wherein trace “D” in FIG. 6 represents the pressure between the sample parts 22, 30. Also at this time, the drive 24 may apply zero torque 152 to the spindle 18 during a thrust phase. Alternatively, the drive 24 may apply a positive 160 or negative torque 162 at this time and thus increase or decrease the energy to be dissipated into the inertia sample weld 138, respectively. In inertia welding, a base input energy for any given material and geometry must generate enough heat to plasticize sufficient material to allow the upset 176 to form. Optionally, at a predetermined “upset speed”, the weld system 10, can increase the axial load on the two sample parts 22, 30 to an “upset pressure” (not shown).

The contact of the meeting faces of the sample parts 22, 30 puts a torque load on the spindle 18 due to the frictional weld torque between the two sample parts 22, 30 during a deceleration phase 164 of the inertia sample cycle 140. This contact causes a deceleration 178 of the spindle 18 to eventually reach a zero velocity 166. At zero velocity 166, the formation of upset 168 may continue. An upset position 170 is determined after the spindle achieves zero velocity 166. A deceleration upset 172 may be calculated based on the difference between upset zero position 156 and the upset position 170. This deceleration upset 172 represents the displacement of the slide 32 and the reduction at length of the sample parts 22, 30 caused by the formation of upset 168 during the deceleration phase 164.

In the formation of the inertia sample weld 138, the upset 168 formed during the part contact deceleration 164 phase is not controlled and is influenced by the natural characteristics of the weld, e.g. metallurgy of materials, geometry, etc. Once the spindle 18 achieves zero velocity 166, the drive 24 commands zero torque 163 to the spindle 18. At zero velocity 166, a cooling dwell period 180 is initiated where weld (or upset) pressure 158 is maintained for a predetermined period of time. During the cooling dwell period 180, the upset 168 may continue to increase. A final upset position 182 is determined after the slide 32 movement toward the spindle 18 ceases. At the end of the cooling dwell period 180, when the slide 32 reaches a rest position, a total upset 184 of the inertia sample weld 138 can be calculated based on the difference between the upset zero position 156 and the final upset position 182. As such, the total upset 184 represents the displacement of the slide 32 and the reduction of lengths of the sample parts 22, 30 caused by the formation of the upset 168 during the inertia sample cycle 140.

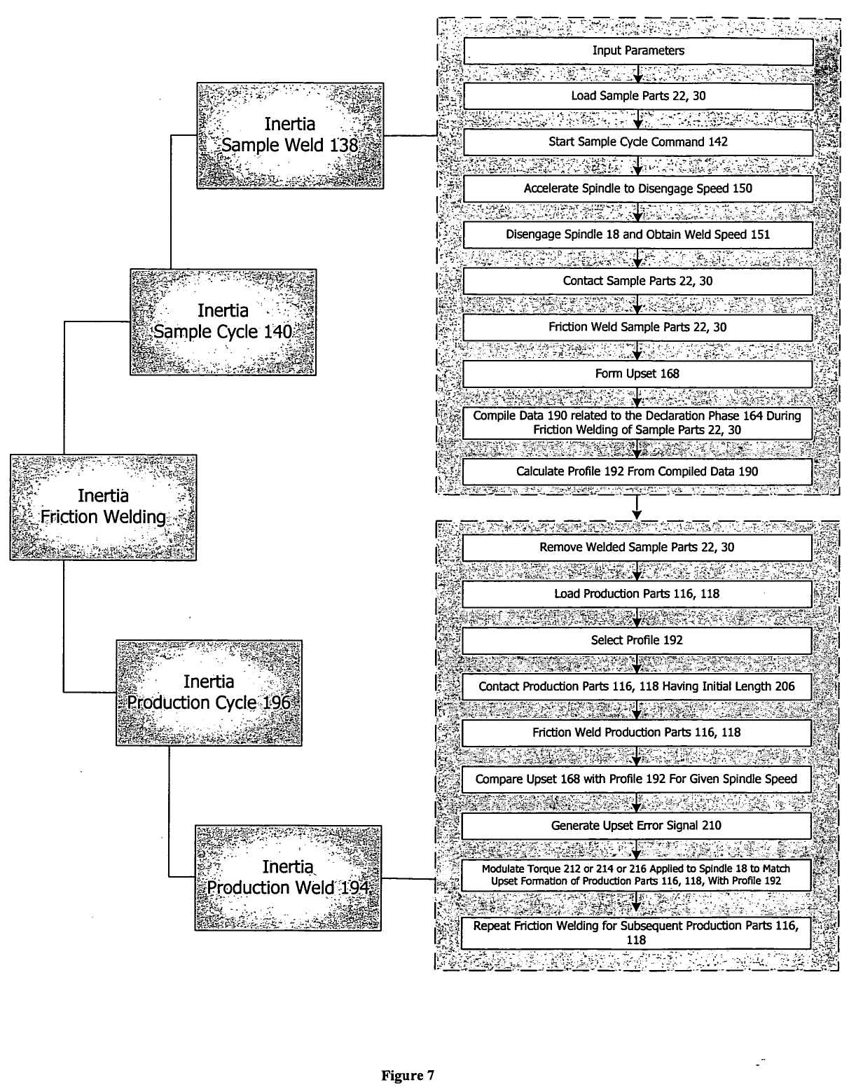

Turning to FIG. 7 and referring to FIG. 6, a flowchart illustrates steps of the inertia sample cycle 140 for the formation of the inertia sample weld 138. As illustrated, the operator first inputs weld parameters that define the inertia sample cycle 140. The operator then loads the pair of sample parts 22, 30 by engaging the first sample part 22 with the rotating chuck 20 connected to the spindle 18 while engaging the second sample part 30 with the non-rotating chuck 28. The operator then issues the start command 142 to initiate the inertia sample cycle 140.

The spindle 18 then rotationally accelerates to the disengage speed 150 wherein the drive 24 then applies zero torque 152 to the spindle 18. The spindle 18 then rotationally decelerates naturally to the preset weld speed 151 wherein the motion controller 26 commands the slide actuator 34 to move the slide 32 to contact the oppose meeting faces of the two sample parts 22, 30 wherein the sample parts 22, 30 have a combined initial length 186 when sample part 30 contacts sample part 22. At initial contact of the meeting faces of sample part 22, 30 the motion controller 26 and the slide encoder 38 establish the upset zero position 156. The contact of the meeting faces of the sample parts 22, 30 puts a torque load on the spindle 18 due to the frictional weld torque between the two sample parts 22, 30 during the part contact deceleration phase 164 of the inertia sample cycle 140. The contact causes the deceleration 178 of the spindle 18 to eventually reach zero velocity 166. At the end of the cooling dwell period 180, the total upset 184 of the inertia sample cycle 140 can be calculated based on the difference between the upset zero position 156 and the final upset position 182. Accordingly, the formation of the inertia sample weld 138 causes the upset to form while reducing the initial length 186 of the sample parts 22, 30 to a final length 188 of the welded sample parts 22, 30.

While executing the inertia sample weld 138, the weld system 10 gathers weld data 190 that can be used to characterize the rotational deceleration of the spindle 18 and the axial movement of the slide 32, and thus, the upset 168, during the part contact deceleration phase 164 of the inertia sample cycle 140 for the specific parts to be welded in subsequent production welds. The upset 168 that forms during the part contact deceleration phase 164 of this sample inertia weld 126 is uncontrolled and therefore subject to some inherent and unpredictable variations. However, the weld data 190 acquired during the inertia sample cycle 140 can be analyzed to determine the upset 168 formed, the speed of the spindle 18 and movement of the slide 32 at various instants in time from the contact of the meeting faces of the sample parts 22, 30 to zero velocity 166 of the spindle 18, i.e., the part contact deceleration phase 164.

During the formation of the inertia sample weld 138, the weld system 10 measures and stores the weld data 190 at specific time intervals. The weld data 190 serve as a basis for calculating the upset versus spindle velocity profile as will be discussed. The weld data 190 are typically measured during the entire weld cycle, but the measurements are particularly critical during the part contact deceleration phase 164 of the inertia sample weld 138. Additionally, thrust pressure may also be measured and stored with the weld data 190. During the formation of the inertia sample weld 138, the weld data 190 are acquired and temporarily stored by the logic controller 42.

When the inertia sample cycle 140 is complete, the CPU 36 reads the weld data 190 from the logic controller 42, displays the results to the operator, and stores a complete record of the weld data 190. The weld data 190 measured and stored can be in any suitable form that can then be used to form additional production welds requiring the same characteristic upset versus spindle velocity profile as was measured during the part contact deceleration phase 164 of the inertia friction sample weld 138. In the illustrated flowchart, the weld data 190 are used to calculate a profile 192. The weld data 190 include the speed of the spindle 18 as a function of time which may be represented as two discrete arrays, one array of spindle speeds and an associated array of time values at which the spindle speed was measured. The weld data 190 used in the calculation of the profile 192 further include position of the slide 32 as a function of time represented as two discrete arrays, one array of slide positions and an associated array of time values at which the slide position was measured. The weld data 190 also include the upset zero position 156 so that upset 168 can be calculated from the slide position data.

The weld data 190 are compiled into the profile 192, wherein the profile 192 is a calculated model of the relationship of the characteristic formation of the upset 168 versus speed of the spindle 18 during the part contact deceleration phase 164 of the inertia sample cycle 140. The profile 192 then serves as a basis for controlling subsequent production welds in order to match the displacement of the sample part 30 caused by the upset 168 at any given spindle velocity during the part contact deceleration phase 164 and, thus, eliminate the inherent upset variation during the part contact deceleration phase 164 in a production inertia weld to produce welded parts with a consistent reduction of lengths as will be discussed.

In the present disclosure, the profile 192 is represented by a lookup table that provides upset 168 formation as a function of speed. In other words, the profile 192 is an array in which the indices of the array are a factor of speed and the values stored in the array represent the upset 168 that was measured at the corresponding spindle speed. Thus, at any given speed, the corresponding upset setpoint can be looked up for that speed. An index is calculated by multiplying the floating point representation of current speed and a floating point representation of a spindle-speed-to-index scaling factor, and rounding the result to produce an integer index. Since the weld data 190 are acquired through digital acquisition rates, the weld data 190 must be interpolated to fill in spindle velocity points where no actual data sample was measured to achieve a complete array of the profile 192.

After the CPU 36 calculates the profile 192 from the weld data 190 of the inertia sample weld 138, the welded component is removed in order to execute any number of subsequent inertia production welds as will be discussed.

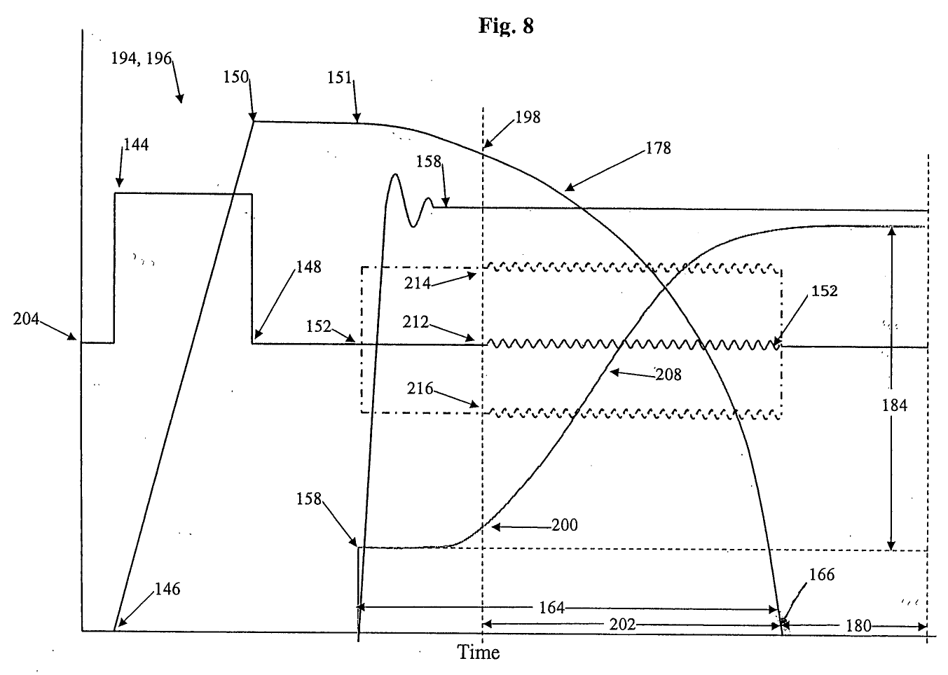

Turning to FIG. 8 and referring to FIG. 7, the formation of an inertia production weld 194 is shown graphically, wherein the horizontal axis represents time and the vertical axis represents various measured values and system commands during formation of the inertia production weld 194, in accordance with an embodiment of the present disclosure. To form the inertia production weld 194, the operator first inputs weld parameters that define an inertia production cycle 196. The operator then loads the pair of production parts 116, 118 (FIG. 1) by engaging the first production part 116 with the rotating chuck 20 (FIG. 1) while engaging the second production part 118 with the non-rotating chuck 28 (FIG. 1).

Additionally, a profile 192 (FIG. 7) is then selected. Any number of inertia sample welds 138 (FIGS. 6 and 7) may be executed, and the weld data 190 from these inertia sample welds 138 may be compiled into various sample profiles 192 and stored on the CPU 36 (FIG. 2). The profile 192 that is most suitable for the current configuration of production parts 116, 118 is selected from the list of available profiles 192.

In inertia welding, a base input energy for any given material and geometry must generate enough heat to plasticize sufficient material to allow the upset 168 to form. Since upset 168 does not start for a period of time after initial contact between the two production parts 116, 118, a parameter must be established to specify when to initiate torque modulation. This can be done in any suitable way, but the two ways illustrated in this disclosure are via a turn-on-speed parameter 198, or via a turn-on-upset parameter 200 as shown in FIG. 8. The turn-on-speed parameter 198 is a predetermined spindle velocity defined such that when the spindle speed drops below that specified value, torque modulation is initiated. The turn-on-upset parameter 200 is defined such that when the upset 168 increases above that specified value, torque modulation is initiated.

The cycle characteristics of the inertia production cycle 196 are identical with the characteristics of the inertia sample cycle 140 through the acceleration phase and until the turn-on-speed or turn-on-upset parameter 198, 200 triggers the initiation of a torque modulation phase 202. Any parameter that affects the rotational deceleration rate of the spindle 18 is unchangeable in the inertia production welds 194, and must be duplicated from the inertia sample weld 138. These parameters include weld speed, brake torque, weld pressure, upset speed, and upset pressure. If these parameters need to be changed, a new inertia sample weld 138 and corresponding profile 192 must be processed and stored. The CPU 36 calculates any additional required parameters based on the parameters input by the operator above and the characteristics of the sample profile 192 selected. All of the parameters, including the profile arrays of upset versus speed are communicated to the logic controller 42 from the CPU 36.

Referring to FIG. 8, the weld system 10 begins inertia friction welding together the pair of production parts 116, 118 to form the inertia production weld 194. After weld parameters are input by the operator and the first production part 116 and the second production part 118 are engaged, the operator then issues the start command 204 for the inertia production cycle 196. After the spindle is accelerated to disengage speed 150 and coasts naturally to weld speed 151, the motion controller 26 then commands the slide actuator 34 to move the slide 32 to contact the opposed meeting faces of the two production parts 116, 118 wherein the production parts 116, 118 have a combined initial length 206 when production part 118 contacts production part 116. The inertia production cycle 196 proceeds as described above in the inertia sample cycle 140. Since the weld is an upset controlled inertia weld, when the turn-on-speed parameter 198 or the turn-on-upset parameter 200 is reached, the torque modulated phase 202 is initiated.

During the torque modulated phase 202 of the inertia production cycle 196, the motion controller 26 compares actual upset 208 forming to the upset setpoint dictated by the profile 192 for the current actual speed of the spindle 18 to generate an upset error signal 210 as shown in the flowchart of FIG. 7. In the present disclosure, the current upset setpoint at any instant in time can be looked up from the profile 192 array based on current spindle 18 speed. The current actual upset 208 can be subtracted from the current upset setpoint to generate the upset error signal 210.

The upset error signal 210 is then used to modulate drive torque 212 applied to the spindle 18 during the torque modulated phase 202. Traces 214 and 216 show the modulated torque signal in the embodiment in which a non-zero brake torque was used in the selected profile 192 of the inertia sample weld 138. Trace 214 shows the modulated torque signal biased around a positive brake torque, and trace 216 shows the modulated torque signal biased around a negative brake torque. If the actual upset 208 forming in the inertia production weld 194 is less than the upset setpoint in the profile 192 at any given speed, the drive 24 applies positive torque to the spindle 18. If the upset 208 forming in the inertia production weld 194 is greater than the upset setpoint in the profile 192 at any given speed, the drive 24 applies negative torque to the spindle 18. Accordingly, during the torque modulated phase 202, the modulated torque 212 or (214, 216) compensates for the upset error signal 210 to form the upset 208 in accordance with the profile 192. As such, the modulated torque continuously increases or decreases the deceleration of the spindle 18 during the torque modulated phase 202 to consistently form the upset 208 in accordance with the formation of upset 168 of the inertia sample weld 138. The upset error signal 210 is driven into a PID algorithm (Proportion—Integral—Derivative) producing the modulated torque signal 212 or (214, 216) that is issued to the spindle 18 to compensate for the upset error signal 210. As such, the modulated torque 212 or (214, 216) applied to spindle 18 during the formation of the inertia production weld 194 causes the upset 208 at any given spindle speed to form in accordance with the profile 192 so that the upset 208 caused during the formation of the inertia production weld 194 is consistent with the upset 168 caused during the formation of the inertia sample weld 138.

In the present disclosure, the closed loop control algorithm for generating the modulated torque command signal based on the current upset error signal 210 is implemented in a standard digital independent positional PID algorithm with derivative on error. Alternatively, the closed loop control algorithm could be implemented in any suitable algorithm including, but not limited to, a dependent algorithm or a velocity algorithm. The algorithms may be implemented in the logic controller 42 in any suitable manner. The inertia production cycle 196 described for the formation of the inertia production weld 194 may be subsequently repeated to weld together on a volume basis any number of additional production parts 116, 118.

Thus, during the inertia production cycle 196, and in particular, the torque modulated phase 202, the drive 24 modulates the torque commands 212 or (214, 216) applied to the spindle 18 so that the upset 208 that occurs in the torque modulated phase 202 of the inertia production weld cycle 196 forms in accordance with the upset 168 that occurred in the part contact deceleration phase 164 of the selected inertia sample weld cycle 140, significantly reducing the variability in upset for the inertia production welds.

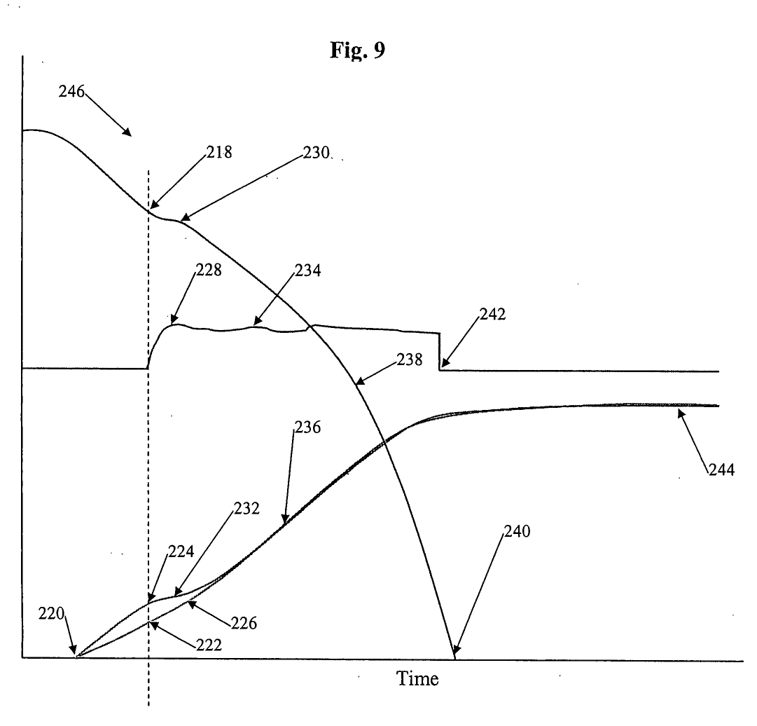

Turning to FIG. 9, in order to illustrate the present disclosure, an example of: upset setpoint, torque command response, spindle angular velocity response, and resultant upset response versus time, is shown. The example shows a typical spindle rotational deceleration that could be the result of an inertia torque modulated deceleration. The principles of this example could also be applied to a direct drive torque modulated deceleration, as will become readily apparent from the following discussion.

Once the speed of the spindle 18 (FIG. 2) falls below the turn-on-speed parameter 218, or the upset 220 increases above the turn-on-upset parameter 222, the motion controller 26 (FIG. 2) begins modulating the torque applied to the spindle 18. Initially, the upset setpoint 224 is much higher then actual upset 226 which creates a positive upset error that is driven into the PID loop. This causes the torque command output to the drive 24 to start to rise in order to attempt to compensate for the upset error calculated as upset setpoint 224 minus actual upset 226. The increased torque command 228 causes a corresponding decrease in the deceleration 230 of the spindle 18. This decrease in the deceleration 230 of the spindle 18 reduces the rate of increase of the upset setpoint 232 since upset setpoint is a function of speed.

The upset error generated at this point in time begins to decrease as the actual upset 226 begins its approach to the upset setpoint 232. The terms of the properly tuned PID loop balance out, as the upset error approaches zero. The integrator contribution from the PID loop holds the torque command 234 steady, since the upset error is near zero and the upset setpoint 232 is approximately equal to the actual upset 236. This near constant torque command 234 causes the speed of the spindle 18 to continue to rotationally decelerate in a smooth manner 238. Once the speed of the spindle 18 reaches zero speed 240, the torque modulation is disabled 242. After the cooling dwell period is complete, final upset 244 of the production weld 246 essentially duplicates the final upset (not shown) dictated by the sample weld (not shown).

Accordingly, the present disclosure in accordance with one embodiment provides a method of friction welding pairs of production parts. The method includes providing a pair of sample parts having a combined initial axial or other length; applying torque to one of the sample parts to rotationally accelerate the one sample part; moving the other sample part toward the one sample part to contact the one sample part; friction welding together the pair of sample parts causing rotational deceleration of the one sample part, further movement of the other sample part toward the one sample part, and the formation of a sample weld causing upset thereby reducing the combined length of the pair of sample parts from the combined initial length to a final welded length; acquiring data related to the rotational deceleration of the one sample part and the movement of the other sample part during the formation of the sample weld; calculating a profile from the acquired data; providing a pair of production parts having a combined initial length of parts; applying torque to one of the production parts to rotationally accelerate the one production part; moving the other production part toward the one production part to contact the one production part; friction welding together the production parts to form a production weld causing rotational deceleration of the one production part and further movement of the other production part toward the one production part; and modulating torque applied to the one production part during the friction welding of the production parts so that the upset formation at any give spindle speed is formed in accordance with the profile so that the upset caused during the formation of the production weld is consistent with the upset caused during the formation of the sample weld. The compiling of the data and the calculating of the profile may be the result of welding more than one, and perhaps many, pairs of sample parts before the profile is employed for use in production. The disclosure also provides a friction weld system including one or more of the features described above.

While the concepts of the present disclosure have been illustrated and described in detail in the drawings and foregoing description, such an illustration and description is to be considered as exemplary and not restrictive in character, it being understood that only the illustrative embodiment has been shown and described and that all changes and modifications that come within the spirit of the disclosure are desired to be protected by the claims set forth below.

The claimed invention is:

1. A method of friction welding pairs of production parts, comprising:
providing a pair of sample parts having a combined initial length;
applying torque to one of the sample parts to rotationally accelerate the one sample part;
moving the other sample part toward the one sample part to contact the one sample part;
friction welding together the pair of sample parts causing rotational deceleration of the one sample part, further movement of the other sample part toward the one sample part, and the formation of a sample weld and also causing upset formation thereby reducing the length of the pair of sample parts from the combined initial length to a welded final length;
acquiring data related to the rotational deceleration of the one sample part and the movement of the other sample part during the formation of the sample weld;
calculating a profile from the acquired data;
providing a pair of production parts having a combined initial length;
applying torque to one of the production parts to rotationally accelerate the one production part;
moving the other production part toward the one production part to contact the one production part;
friction welding together the pair of production parts causing rotational deceleration of the one production part, further movement of the other production part toward the one production part, and the formation of a production weld which causes upset formation thereby reducing the combined initial length of the production parts to a final welded length; and
modulating torque applied to the one production part during the friction welding of the pair of production parts so that the upset formation of the pair of production parts is formed in accordance with the profile so that the upset caused during the formation of the production weld is consistent with the upset caused during the formation of the sample weld.

2. The method of claim 1 further comprising measuring an upset deceleration position when the one sample part begins rotationally decelerating during friction welding of the pair of sample parts.

3. The method of claim 2 further comprising rotationally decelerating the one sample part to zero velocity and allowing the other sample part to reach a rest position after formation of the sample weld.

4. The method of claim 3 further measuring a final upset position after the formation of the sample weld.

5. The method of claim 4 further comprising measuring a displacement of the movement of the other sample part caused by the upset, the displacement of the other sample part being measured between the upset deceleration position and the final upset position.

6. The method of claim 5 wherein the other sample part is moved by a slide and wherein acquiring the data during the formation of the sample weld comprises measuring the displacement of the other sample part as a function of time.

7. The method of claim 6 wherein acquiring the data during formation of the sample weld comprises measuring a rotational speed of the one sample part during rotational deceleration of the one sample part as a function of time.

8. The method of claim 7 wherein calculating the profile includes modeling the relationship of the rotational speed of the one sample part with the displacement of the other sample part.

9. The method of claim 8 wherein modulating torque during formation of the production weld comprises matching the displacement of the other sample part caused during the formation of the sample weld.

10. The method of claim 1 further comprising disengaging the torque during the rotational deceleration of the one sample part.

11. The method of claim 1 further comprising braking the one sample part during rotational deceleration of the one sample part.

12. The method of claim 1 wherein providing the pair of sample parts includes engaging the one sample part with a spindle and wherein providing the pair of production parts includes engaging the one production part with the spindle.

13. The method of claim 1 wherein providing the pair of sample parts includes engaging the other sample part with a slide and wherein providing the pair of production parts includes engaging the other production part with the slide.

14. The method of claim 1 further comprising specifying a dimension for the welded final length of the pair of production parts before rotationally accelerating the one production part.

15. The method of claim 14 further comprising controlling initiation of the rotational deceleration of the one production part during friction welding so that the sum of the upset formed prior to the rotational deceleration of the one production part with the upset formed during and after the rotational deceleration of the one production part reduces the welded final length of the pair of production parts to obtain the specified dimension.

16. The method of claim 15 wherein the combined initial and welded final lengths of the pair of sample production parts and the pair of production part comprise combined initial and welded final axial lengths.

17. A method of friction welding pairs of production parts, comprising:
(a) providing a pair of sample parts having a combined initial length;
(b) applying torque to one of the sample parts to rotationally accelerate the one sample part;
(c) moving the other sample part toward the one sample part to contact the other sample part;
(d) friction welding together the sample parts to form a sample weld causing rotational deceleration of the one sample part and further movement of the other sample part toward the one sample part, and also causing upset thereby reducing the length of the pair of sample parts from the combined initial length to a welded final length;
(e) acquiring data related to the rotational deceleration of the one sample part and the movement of the other sample part during the formation of the sample weld;
(f) calculating a profile from the acquired data; and
(g) forming a plurality of production welds by:
(i) providing a pair of production parts having a combined initial length;
(ii) applying torque to one of the production parts to rotationally accelerate the one production part;
(iii) moving the other production part toward the one production part to contact the one production part;
(iv) friction welding together the production parts to form a production weld causing rotational deceleration of the one production part and further movement of the other production part and also causing upset thereby reducing the length of the pair of production parts from the combined initial length to a final welded length of the production parts;
(v) modulating torque applied to the one production part during the friction welding of the pair of production parts so that the upset formation of the pair of production parts is formed in accordance with the profile so that the upset caused during the formation of the production weld is consistent with the upset cause during the formation of the sample weld; and (vi) repeating (i)-(v) above with other pairs of production parts.

18. The method of claim 17 further comprising measuring an upset deceleration position when the one sample part begins rotationally decelerating during the friction welding of the pair of sample parts.

19. The method of claim 18 further comprising decelerating the one sample part to zero velocity and allowing the other sample part to reach a rest position and measuring a final upset position after formation of the sample weld.

20. The method of claim 19 further comprising measuring a displacement of the movement of the other sample part caused by the upset, the displacement of the other sample part being measured between the upset deceleration position and the final upset position.

21. The method of claim 20 further comprising moving the other sample part by a slide and wherein acquiring the data during the formation of the sample weld comprises measuring the displacement of the other sample part as a function of time.

22. The method of claim 21 wherein acquiring the data during formation of the sample weld comprises measuring a rotational speed of the one sample part during rotational deceleration as a function of time.

23. The method of claim 22 wherein calculating the profile includes modeling the relationship of the speed of the one sample part with the displacement of the other sample part.

24. The method of claim 23 wherein modulating torque during formation of the production weld comprises matching the displacement of the other sample part caused during the formation of the sample weld.

25. A friction weld system for welding pairs of production parts, the system comprising:
a spindle associated with a rotating chuck, the rotating chuck configured to engage one of each pair of production parts for welding with the other of each pair of production parts;
a slide associated with a non-rotating chuck, the non-rotating chuck configured to engage the other of each pair of production parts, the slide being configured to move the non-rotating chuck toward the rotating chuck to facilitate welding together of the each pair of production parts;
a drive operatively connected to the spindle to apply torque to the spindle to rotate the spindle;
a motion controller operatively connected to the drive and the slide, the motion controller being configured: to engage the drive to apply torque to the spindle to rotationally accelerate the spindle and to engage the slide to move toward the spindle to friction weld together each pair of production parts to form a production weld which causes rotational deceleration of the spindle;
a logic controller operatively connected to the motion controller, the logic controller being configured to store data related to the rotational deceleration of the spindle during the formation of a sample weld during friction welding together of a pair of sample parts and to communicate with the motion controller which modulates the torque applied to the spindle during formation of production welds during subsequent welding together of pairs of production parts so that upset formed during the formation of the production welds is formed in accordance with the profile so that the upset during formation of the production weld is consistent with the upset formed during the formation of the sample weld; and
a central processing unit operatively connected to the logic controller, the central processing unit configured to calculate a profile based on data stored during the welding together of the pair of sample parts.

26. The system of claim 25 wherein the logic controller is also configured to store data related to the movement of the slide during the formation of the sample weld and is also configured to communicate with the motion controller during formation of the production weld so that the movement of the slide matches the profile calculated from the formation of the sample weld.

27. The system of claim 25 wherein a speed measurer is configured to measure a rotational speed of the spindle during deceleration of the spindle.

28. The system of claim 27 wherein a slide encoder is configured to measure a movement of the slide.

29. The system of claim 28 wherein the central processing unit is configured to calculate the profile as modeling the relationship of the speed of the spindle with the movement of the slide.
